(19) United States
(12) Patent Application Publication
(10) Pub. No.: US 2024/0362954 A1
(43) Pub. Date: Oct. 31, 2024

(54) SIMULATOR BASED VEHICLE DIAGNOSTICS

(71) Applicant: Innova Electronics Corporation, Irvine, CA (US)

(72) Inventors: Ly Bach, Ho Chi Minh City (VN); Phuong Pham, Fountain Valley, CA (US)

(21) Appl. No.: 18/228,532

(22) Filed: Jul. 31, 2023

Related U.S. Application Data
(60) Provisional application No. 63/499,178, filed on Apr. 28, 2023.

(51) Int. Cl. G07C 5/00; G07C 5/08

(52) U.S. Cl. CPC G07C 5/008; G07C 5/0808; G07C 2205/02

(57) ABSTRACT

A method of providing vehicle diagnostics includes receiving diagnostic data collected from an on-board diagnostics (OBD) port of a vehicle, the diagnostic data including identification information of the vehicle and at least one diagnostic trouble code (DTC) or other fault indication associated with a component of the vehicle. The method may further include deriving, from the at least one fault indication and the identification information, one or more simulated output parameters for simulating an output of the component, receiving live data collected from the OBD port of the vehicle based on a simulated output of the component generated according to the one or more simulated output parameters, and deriving vehicle condition information from the at least one fault indication and the live data.

### CROSS-REFERENCE TO RELATED APPLICATIONS

This application claims priority to U.S. Provisional Application Ser. No. 63/499,178, filed Apr. 28, 2023, the entire contents of which is expressly incorporated by reference herein.

### STATEMENT RE: FEDERALLY SPONSORED RESEARCH/DEVELOPMENT

Not Applicable

### BACKGROUND

A set of diagnostic trouble codes (DTCs) produced from a diagnostic scan of a vehicle may provide a helpful indication of what sorts of problems might be present in the vehicle. However, considering the complexity of the various electrical and other systems operating within the vehicle, as well as the many different types of vehicles having differently designed vehicle parts, it remains a nontrivial problem for a technician to determine the root cause of a given set of DTCs. For this reason, technicians may additionally consult live data of the vehicle that may be associated with one or more of the DTCs in an effort to narrow down the possibilities and judge what is the most likely underlying problem. Unfortunately, consulting live data may often still be insufficient, especially in the case of DTCs associated with any of a vehicle's many sensors such as oxygen sensors and mass airflow sensors. When suspecting a faulty sensor, a technician will typically remove the suspected sensor and replace it with a known good sensor, only to find that the problem persists. There may, for example, be a problem with some other related system such as the wiring of the sensor, rather than with the sensor itself. In these cases, the typical diagnostic procedure of replacing the sensor may waste time and money.

### BRIEF SUMMARY

The present disclosure contemplates various systems and methods for overcoming the above drawbacks accompanying the related art. Upon performing a diagnostic scan of a vehicle using an automotive scan tool or other diagnostic tool connected to the vehicle's on-board diagnostic (OBD) port, a technician (or vehicle owner) may be confronted with a diagnostic trouble code (DTC) or other fault indication that points to a failure in some sensor or other component of the vehicle. Rather than swapping out the potentially faulty component for a new one, the technician may instead take advantage of the disclosed systems and methods to simulate a properly working version of the component in question in order to help isolate the cause of the failure. The disclosed system functionality, which may be embodied in the diagnostic tool itself or in a remote server, may derive all of the necessary parameters for simulating the component using a handheld simulator tool that may be connected to the vehicle at the position of the component being simulated. The parameters may define the appropriate sensor output patterns, voltages, resistances, etc., all of which may be designated to fall within the correct ranges for the specific component in question in the specific type of vehicle (e.g., year/make/model/engine) as derived from the diagnostic scan. The parameters may additionally include instructions to assist the technician with connecting the appropriate leads of the simulator tool to the vehicle and, if necessary, partially or wholly disconnecting the component itself. Various iterations of the disclosed system are contemplated herein in regard to manually (e.g., by user input) or automatically programming the simulator tool according to the parameters. In a particularly streamlined iteration, the diagnostic tool and simulator tool may be one and the same device, having both means (typically wireless) for connecting to the OBD port of the vehicle along with leads for providing the simulated output signals to the appropriate point in the vehicle as determined for the specific component in question in the specific type of vehicle under test (e.g., year/make/model/engine).

Once the vehicle is receiving the simulated output in place of the actual output of the component under investigation, the diagnostic tool may be used to collect live data from the vehicle. Because the live data is based on the simulated output, it can be assumed that any defect in the live data is caused by something other than the component in question. Thus, the technician (or the diagnostic tool or server) may conclude that some other fault is to blame, such as a problem in the ECU or in the wiring associated with the component and not the component itself. On the other hand, live data that matches expected values may be understood to mean that the component itself is defective. In this way, the disclosed systems and methods may help the technician determine the underlying cause of the original DTC without having to resort to unnecessary installation of a known working component. This may be especially advantageous in the case of sensors that are difficult and time consuming for a technician to install and bring to a working state, such as oxygen sensors, coolant temperature sensors, and exhaust gas temperature sensors.

One aspect of the embodiments of the present disclosure is a method of providing vehicle diagnostics. The method may comprise receiving diagnostic data collected from an on-board diagnostics (OBD) port of a vehicle. The diagnostic data may include identification information of the vehicle and at least one diagnostic trouble code (DTC) or other fault indication associated with a component of the vehicle. The method may further comprise deriving, from the at least one fault indication and the identification information, one or more simulated output parameters for simulating an output of the component, receiving live data collected from the OBD port of the vehicle based on a simulated output of the component generated according to the one or more simulated output parameters, and deriving vehicle condition information from the at least one fault indication and the live data.

Another aspect of the embodiments of the present disclosure is a computer program product comprising one or more non-transitory program storage media on which are stored instructions executable by one or more processors or programmable circuits to perform operations for providing vehicle diagnostics. The operations may comprise receiving diagnostic data collected from an on-board diagnostics (OBD) port of a vehicle. The diagnostic data may include identification information of the vehicle and at least one diagnostic trouble code (DTC) or other fault indication associated with a component of the vehicle. The operations may further comprise deriving, from the at least one fault indication and the identification information, one or more simulated output parameters for simulating an output of the component, receiving live data collected from the OBD port of the vehicle based on a simulated output of the component generated according to the one or more simulated output parameters, and deriving vehicle condition information from the at least one fault indication and the live data.

Another aspect of the embodiments of the present disclosure is a system for providing vehicle diagnostics. The system may comprise a diagnostic tool operable to receive diagnostic data collected from an on-board diagnostics (OBD) port of a vehicle. The diagnostic data may include identification information of the vehicle and at least one diagnostic trouble code (DTC) or other fault indication associated with a component of the vehicle. The diagnostic tool may be further operable to derive, from the at least one fault indication and the identification information, one or more simulated output parameters for simulating an output of the component. The system may further comprise a simulator operable to generate a simulated output of the component according to the one or more simulated output parameters.

The diagnostic tool may be further operable to receive live data collected from the OBD port of the vehicle based on the simulated output and derive vehicle condition information from the at least one fault indication and the live data. The deriving of the vehicle condition information by the diagnostic tool may include uploading the at least one fault indication and the live data to one or more servers and receiving the vehicle condition information from the one or more servers. Along the same lines, the deriving of the one or more simulated output parameters may include uploading the at least one fault indication and the identification information to one or more servers and receiving the one or more simulated output parameters from the one or more servers.

Another aspect of the embodiments of the present disclosure is a system for providing vehicle diagnostics. The system may comprise one or more servers operable to receive diagnostic data collected from an on-board diagnostics (OBD) port of a vehicle. The diagnostic data may include identification information of the vehicle and at least one diagnostic trouble code (DTC) or other fault indication associated with a component of the vehicle. The one or more servers may be further operable to derive, from the at least one fault indication and the identification information, one or more simulated output parameters for simulating an output of the component. The system may further comprise a simulator operable to generate a simulated output of the component according to the one or more simulated output parameters.

The one or more servers may be further operable to receive live data collected from the OBD port of the vehicle based on the simulated output and derive vehicle condition information from the at least one fault indication and the live data.

Another aspect of the embodiments of the present disclosure is a system for providing vehicle diagnostics. The system may comprise a data acquisition and transfer device configured to be plugged into an on-board diagnostics (OBD) port of a vehicle and a diagnostic tool operable to receive diagnostic data collected from the vehicle via the data acquisition and transfer device. The diagnostic data may include identification information of the vehicle and at least one diagnostic trouble code (DTC) or other fault indication associated with a component of the vehicle. The diagnostic tool may be further operable to derive, from the at least one fault indication and the identification information, one or more simulated output parameters for simulating an output of the component and generate a simulated output of the component according to the one or more simulated output parameters. The diagnostic tool may be further operable to receive live data collected from the vehicle via the data acquisition and transfer device. The live data may be based on the simulated output.

The diagnostic tool may be further operable to derive vehicle condition information from the at least one fault indication and the live data. The deriving of the vehicle condition information by the diagnostic tool may include uploading the at least one fault indication and the live data to one or more servers and receiving the vehicle condition information from the one or more servers. Along the same lines, the deriving of the one or more simulated output parameters may include uploading the at least one fault indication and the identification information to one or more servers and receiving the one or more simulated output parameters from the one or more servers.

In any of the above methods, computer program products, systems, and diagnostic tools, the one or more simulated output parameters may include at least one parameter for generating a simulated output selected from the group consisting of a simulated resistance, a simulated voltage, a simulated sine wave, a simulated square wave, a simulated temperature coefficient sensor output, a simulated throttle and pedal sensor output, a simulated oxygen sensor output, a simulated exhaust gas pressure sensor output, a simulated camshaft position (CMP) sensor output, a simulated crankshaft position (CKP) sensor output, a simulated common rail pressure sensor output, a simulated knock sensor output, a simulated manifold absolute pressure (MAP) sensor output, a simulated anti-lock braking system (ABS) sensor output, a simulated mass airflow (MAF) sensor output, a simulated heating, ventilation, and air conditioning (HVAC) pressure sensor output, a simulated signal for controlling an injector pulse of the vehicle, a simulated signal for controlling an ignitor pulse of the vehicle, and a simulated signal for controlling a solenoid pulse of the vehicle.

In any of the above methods, computer program products, systems, and diagnostic tools, the one or more simulated output parameters may include user instructions for connecting a simulator to the vehicle, the simulator being operable to generate the simulated output of the component.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for providing vehicle diagnostics according to one or more embodiments of the present disclosure;

FIG. 2 shows an operational flow for providing vehicle diagnostics according to one or more embodiments of the present disclosure;

FIG. 3 shows a schematic view of the disclosed system and diagnostic methods;

FIG. 4 shows another operational flow associated with the disclosed system and diagnostic methods;

FIG. 5 shows another operational flow associated with the disclosed system and diagnostic methods;

FIG. 6 shows another schematic view of the disclosed system; and

FIG. 7 shows another schematic view of the disclosed system.

### DETAILED DESCRIPTION

The present disclosure encompasses various embodiments of systems and methods for providing vehicle diagnostics. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

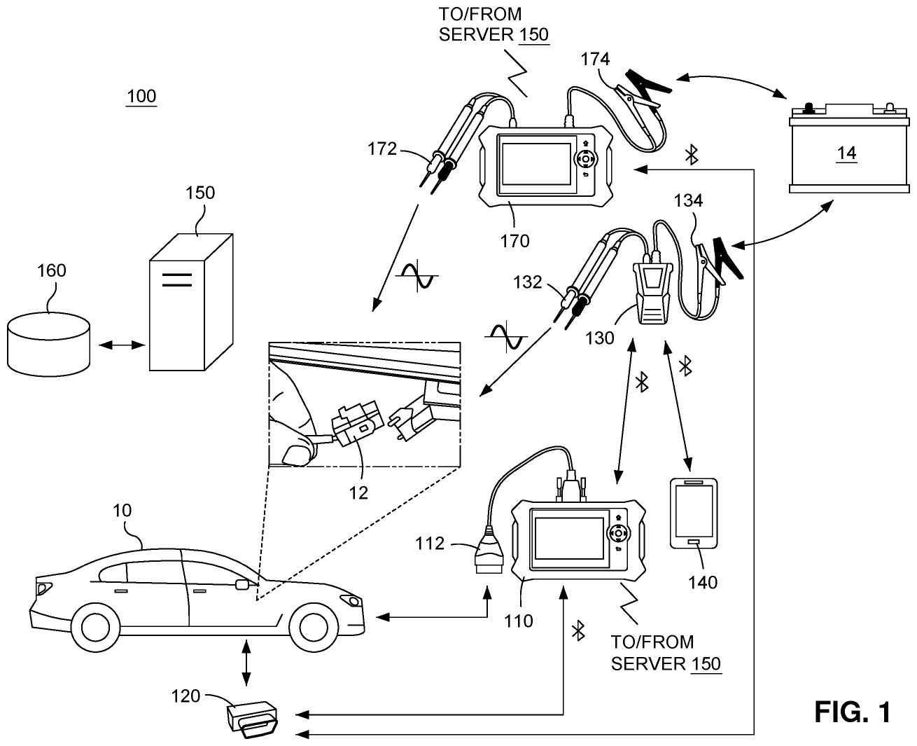

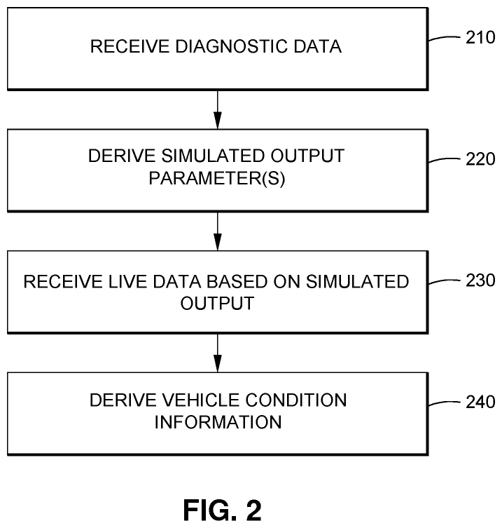

FIG. 1 shows a system 100 for providing vehicle diagnostics according to one or more embodiments of the present disclosure. The system 100 may allow a technician or vehicle owner to quickly and efficiently determine the true source of a diagnostic trouble code (DTC) that is associated with a faulty sensor or other component of the vehicle 10. Referring also to the operational flow of FIG. 2, a diagnostic methodology using the system 100 may begin with receiving diagnostic data collected from an on-board diagnostics (OBD) port of the vehicle 10 (step 210). For example, in a relatively simple iteration, a diagnostic tool 110 such as an automotive scan tool may be connected by an attached cable 112 to an OBD port of the vehicle 10 to collect the diagnostic data from an onboard computer (e.g., an ECU) of the vehicle 10. Alternatively, the diagnostic tool 110 may collect the diagnostic data by communicating using a shortrange wireless communication protocol (e.g., Bluetooth) with a data acquisition and transfer device (DAT) or dongle 120 that is plugged into the OBD port. The received diagnostic data, which may include DTCs, vehicle sensor data, freeze frame data, and/or live data, may indicate that something is wrong with a particular sensor or other component 12 of the vehicle 10. This might ordinarily prompt a technician to replace the component in question as a first step of diagnosing the problem. However, upon follow-up testing, it may be discovered that the component 12 was not to blame after all, but that the problem arose downstream due to a bad ECU or faulty wiring, for example, making the replacement of the component 12 a waste of time and money. Therefore, advantageously, the system 100 may instead assist the technician or vehicle owner with a process of simulating a properly working version of the component 12 in question so as to remove the possibility that the component 12 is faulty when conducting follow-up testing. In this way, the system 100 may allow the true source of the problem to be isolated without unnecessarily replacing the sensor or other component suggested by the diagnostic data.

Simulation of the possibly faulty component 12 in question may, in this relatively simple iteration, be done by a simulator 130 that is operable to simulate a working output of the component 12, including in some cases a simulated actuator control signal. The simulator 130 may, for example, have any of the features of sensor simulators as described in U.S. Patent Application Pub. No. 2014/0005881, entitled “AUTOMOTIVE DIAGNOSTIC SYSTEM,” the entire contents of which is expressly incorporated by reference herein. Depending on the nature of the component 12, the simulated output may be a simulated resistance, a simulated voltage, a simulated sine wave, a simulated square wave, a simulated temperature coefficient sensor output, a simulated throttle and pedal sensor output, a simulated oxygen sensor output, a simulated exhaust gas pressure sensor output, a simulated camshaft position (CMP) sensor output, a simulated crankshaft position (CKP) sensor output, a simulated common rail pressure sensor output, a simulated knock sensor output, a simulated manifold absolute pressure (MAP) sensor output, a simulated anti-lock braking system (ABS) sensor output, a simulated mass airflow (MAF) sensor output, a simulated heating, ventilation, and air conditioning (HVAC) pressure sensor output, a simulated signal for controlling an injector pulse of the vehicle, a simulated signal for controlling an ignitor pulse of the vehicle, or a simulated signal for controlling a solenoid pulse of the vehicle. One or more leads 132 (e.g., test probes, alligator clips, etc.) of the simulator 130 may be connected to the vehicle 10 just downstream of the component 12 (which may itself be removed, if necessary) so as to provide the simulated output to the vehicle 10 in place of the actual output of the component 12. If follow-up testing indicates no more problem, then it may be concluded that the component 12 was at fault. If the problem persists, it may rather be deduced that the problem is not the component 12 itself but something downstream of or otherwise associated with the component 12, such as a wiring problem or a problem with the ECU.

In the simplest case, the simulator 130 need not be in communication with the diagnostic tool 110 and may be manually programmed to generate the correct simulated output for the component 12 in question. As shown in FIG. 1, for example, a mobile device 140 such as smartphone or tablet may have an installed application (e.g., a mobile app) that allows the mobile device 140 to interface with the simulator 130, such as via shortrange wireless communication (e.g., Bluetooth) as illustrated. The technician or vehicle owner (i.e., the user) may simply input to the mobile device 140 the required parameters for correct simulation of the component 12, and the simulator 130 may generate the simulated output accordingly. The simulator 130 may be conveniently powered by the vehicle battery 14 via battery cable clamps 134 as shown in FIG. 1.

Advantageously, the system 100 may assist the user with programming the simulator 130 in this fashion, as well as with connecting the simulator 130 to the vehicle and, if necessary, disconnecting the component 12 in question. To this end, the system 100 may leverage identification information of the vehicle 10 that is included in the diagnostic data collected from the OBD port. The identification information may include year, make, model, engine, trim, etc. (e.g., YMME) of the vehicle 10, indicative of the specific type of vehicle, and/or a vehicle identification number (VIN) corresponding to the exact vehicle. Such identification information may be used to determine the exact type of sensor or other component 12 that is installed. The operational flow of FIG. 2 may thus continue with deriving, from the at least one DTC and the identification information, one or more simulated output parameters for simulating the output of the component 12 (step 220). This may be done by the diagnostic tool 110 automatically upon receiving diagnostic data including a DTC that suggests a fault associated with the component 12, for example, by referencing a lookup table cross-referenced with the identification information. The simulated output parameter(s) may include user instructions for connecting the simulator 130 to the vehicle 10, which may include information about which leads 132 to use (e.g., there may be various cable attachments depending on which component 12 is being simulated for which vehicle), where to connect the leads 132, and, if necessary, how to disconnect the actual component 12 or a portion thereof. The simulated output parameter(s) may further include at least one parameter for generating the appropriate simulated output, e.g., which settings to use when programming the simulator 130 so that it correctly simulates a working output of the component 12 in question. In some cases, one or more DTCs might be analyzed to determine which sensor or other component 12 needs to be simulated, with the YMME or other identification information subsequently being used to determine the construction and operating characteristics and other parameters associated with the component 12 that is installed in the vehicle under test (e.g., to compose data for a CAN bus message with address, byte, and bit position for that particular sensor or other component 12). The user may then program the simulator 130 accordingly using the mobile device 140.

Once the simulator 130 is connected to the vehicle 10 and correctly generating a simulated working output of the component 12 (e.g., by sending a CAN bus command or other message that is the same as broadcast data of a working component 12 having, for example, the expected address, byte, and bit position), the operational flow of FIG. 2 may continue with receiving live data collected from the OBD port of the vehicle 10 based on the simulated output (step 230). The diagnostic tool 110 may again be connected (or may remain connected) to the OBD port of the vehicle 10 by the cable 112 or via the dongle 120 to collect the live data from an onboard computer (e.g., an ECU) of the vehicle 10. The live data may, in particular, include real-time data of the vehicle 10 that is dependent upon the component 12 correctly functioning. For example, in a case where the component 12 is a throttle position sensor (TPS) and the simulator 130 is generating a simulated TPS output, the simulator 130 might generate a first simulated Hall effect sensor output (e.g., VTA1 on a 2015 Toyota Camry) by varying an output voltage corresponding to a throttle opening range (e.g., 0.69-3.54V corresponding to 0-100%) while further generating a second simulated Hall effect sensor output (e.g., VTA2) that is calculated based on the first (e.g., VTA2=(VTA1+1.11)/0.8). The simulated outputs may be connected to the corresponding pins of an electronic control module (ECM) in place of the actual TPS output. The relevant live data, e.g., TPS percentage, may then be collected from the vehicle 10 and compared to an expected TPS percentage corresponding to the simulated output.

The operational flow may conclude with deriving vehicle condition information from the DTC(s) and the live data (step 240). In the simplest case, the user may manually compare the live data output with expected data, e.g., by looking up expected data associated with the simulated output parameter(s) for the particular component 12 in question. If there is a match, then it may be concluded that the component 12 was bad. That is, since the live data is not indicating a problem based on the simulated component output, the original DTC was likely generated due to a fault in the component 12 itself. On the other hand, if the live data does not match the expected data, then it may be concluded that the fault lies in the wiring, ECU, or some other component downstream of the component 12 that was associated with the DTC. The vehicle condition information may thus indicate that the component 12 is bad or that the wiring, etc. is bad based on the combination of the original DTC and the live data collected while simulating the component 12. There is no need to undergo the cost of installing and setting up a new component 12 as part of the diagnostic procedure.

It is noted that all or a portion of the operational flow of FIG. 2 may be performed by the diagnostic tool 110. That is, the diagnostic tool 110 may receive the diagnostic data from the vehicle in step 210 and, subsequently, receive the live data from the vehicle 10 based on the simulated output of the simulator 130 in step 230. Advantageously, in order to assist the user in operating the simulator 130, the diagnostic tool 110 may also derive the simulated output parameter(s) in step 220, which may include simulator settings and/or user instructions as described above. The diagnostic tool 110 may derive the simulated output parameter(s) locally (e.g., by referencing one or more lookup tables stored on the diagnostic tool 110) or by requesting the relevant parameter(s) from one or more servers 150 in communication with the diagnostic tool 110 over a network such as the Internet. The request may include the DTC(s) and the identification information of the vehicle 10, and the server(s) 150 may return the parameter(s) derived therefrom. Along the same lines, deriving the vehicle condition information in step 240 may likewise be performed automatically by the diagnostic tool 110 rather than entailing merely a manual comparison of the live data output with expected data as described above. That is, the diagnostic tool 110 may derive the vehicle condition information locally or may request the vehicle condition information from the one or more servers 150. Along the same lines, it should be recognized that an app installed on the mobile device 140 may similarly function with reference to information retrieved from the server(s) 150.

In this regard, it may be appreciated that the diagnostic tool 110 may, in general, upload diagnostic data collected from the vehicle 10 to the one or more servers 150, which may derive vehicle condition information from the uploaded diagnostic data by comparing the uploaded diagnostic data with data stored in one or more diagnostic databases 160. Exemplary diagnostic methods, including the use of such diagnostic data to arrive at a most likely root cause and repair solution, are described in the following U.S. patent documents, each of which is owned by Innova Electronics Corporation of Irvine, California: U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,068,951, entitled VEHICLE DIAGNOSTIC SYSTEM, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIXED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 9,824,507, entitled MOBILE DEVICE BASED VEHICLE DIAGNOSTIC SYSTEM, U.S. Pat. No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, and U.S. Patent Application Pub. No. 2019/0304213, entitled SYSTEM AND METHOD FOR PROACTIVE VEHICLE DIAGNOSIS AND OPERATIONAL ALERT, the entire contents of each of which is expressly incorporated by reference herein. In the context of step 240, the vehicle condition information may be derived by the server 150 on the basis of both the original diagnostic data including the DTC(s) associated with the potentially faulty component 12 and the live data collected using the simulated output data of the component 12.

Just as all or a portion of the operational flow of FIG. 2 may be performed by the diagnostic tool 110, it is contemplated that all or a portion of the operational flow of FIG. 2 may be performed by the one or more servers 150. In this regard, the server(s) 150 may receive the diagnostic data from the diagnostic tool 110 in step 210 and derive the simulated output parameter(s) in step 220, which may be communicated back to the diagnostic tool 110 (or in some cases to the mobile app installed on the mobile device 140) to inform the user of how to properly set up the simulator 130. Subsequently, the server(s) 150 may receive the live data from the diagnostic tool 110 in step 230, the live data having been collected from the vehicle 10 based on the simulated output of the simulator 130. Based on the live data and the original diagnostic data, the server(s) 150 may then derive the vehicle condition information (e.g., using one or more diagnostic databases 160) in step 240 and provide the vehicle condition information back to the user on the diagnostic tool 110 (or mobile device 140). It is contemplated that the server(s) 150 may associate the vehicle 10 with the user of the mobile application through the use of a user profile linked to the VIN of the vehicle 10 as described in the following U.S. patent documents, each of which is owned by Innova Electronics Corporation of Irvine, California: U.S. Pat. No. 11,335,139, entitled SYSTEM AND METHOD FOR SELECTIVE VEHICLE DATA RETRIEVAL, U.S. Pat. No. 11,455,841, entitled SYSTEM AND METHOD FOR SELECTIVE VEHICLE DATA RETRIEVAL, and U.S. Patent Application Pub. No. 2023/0063381, entitled SYSTEM, METHOD, AND COMPUTER PROGRAM PRODUCT FOR PROVIDING APPLICATION-BASED ASSISTANCE WITH VEHICLE EMISSION TEST COMPLIANCE, the entire contents of each of which is expressly incorporated by reference herein.

Referring again to FIG. 1, various other iterations of the disclosed diagnostic methodology are contemplated that may further streamline and/or automate the process. The diagnostic tool 110 may, for example, be capable of directly communicating with the simulator 130, e.g., using a shortrange wireless communication protocol (e.g., Bluetooth). In this case, the functionality for programming the simulator 130 may be included in the diagnostic tool 110 itself, with the parameters and settings for correctly running the simulator 130 being conveyed directly from the diagnostic tool 110 to the simulator 130. The mobile device 140 may thus be omitted, and the user may operate the diagnostic tool 110 itself to program the simulator 130 rather than using a separate mobile app. With such an arrangement, it is further contemplated that the user's role in programming the simulator 130 can be eliminated completely, with the user only being needed for the physical connection of the simulator 130 to the vehicle 10 via the leads 132. Following step 220 of FIG. 2, in which the simulated output parameter(s) are derived by the diagnostic tool 110 and/or the server(s) 150, the diagnostic tool 110 may autonomously control the simulator 130 according to the parameter(s) without requiring user input (or, in some cases, only requiring a user to tap “proceed” on the diagnostic tool 110). The autonomous operation of the diagnostic tool 110 may flow all the way from the appearance of the DTC associated with the faulty component 12. Once such a DTC is recognized, the simulated output parameter(s) may be automatically generated and the simulator 130 automatically programmed by the diagnostic tool 110 to generate the simulated output of a properly working version of the same component 12 for the particular type of vehicle identified by the identification information.

Further streamlining of the processes described herein may be achieved through the use of an enhanced diagnostic tool 170 (e.g., an enhanced automotive scan tool) having built-in simulator functionality in place of the separate diagnostic tool 110 and simulator 130 described above. The diagnostic tool 170 may have one or more leads 172 that are the same as the one or more leads 132 of the simulator 130 (and may comprise various cable attachments depending on which component 12 is being simulated) and may likewise be connected to the vehicle 10 so as to provide simulated output of the component 12 to the vehicle 10. The diagnostic tool 170 may be powered by the vehicle battery 14 using battery cable clamps 174. So as to allow the user to freely move about the vehicle 10 (e.g., under the hood) to connect the leads 172 of the diagnostic tool 170 to the appropriate point(s), it can be appreciated that the diagnostic tool 170 may typically collect the diagnostic data from the vehicle 10 by communicating using a shortrange wireless communication protocol (e.g., Bluetooth) with a data acquisition and transfer device (DAT) or dongle 120 that is plugged into the OBD port. The use of a cable 112 as described in relation to the diagnostic tool 110 is, however, also contemplated.

The enhanced diagnostic tool 170 may act as a standalone device that both collects the diagnostic data (including DTCs and live data as well as identification information) from the vehicle 10 and simulates the output of the sensor or other component 12 whose proper functioning is called into question by one or more DTCs. Thus, with reference to the operational flow of FIG. 2, the diagnostic tool 170 (and/or server(s) 150 in communication therewith) may receive the diagnostic data in step 210 and derive the simulated output parameter(s) in step 220, which, in addition to parameter(s) for generating the correct simulated output for the particular component 12 and vehicle 10, may also include on-screen instructions for how the user should physically connect the diagnostic tool 170 to the vehicle 10. The same diagnostic tool 170 may then autonomously program itself (or be programmed by the server(s) 150) to generate the correct simulated output. Then, and in some cases after a user taps a “proceed” button indicating that the leads 172 are correctly attached, the diagnostic tool 170 may begin the simulated output, namely, simulating the output of a properly working version of the component 12 so that downstream components in the vehicle 10 receive what appears to be a signal that is within an expected range and normal. Once the simulated output is being generated, the diagnostic tool 170 may collect live data from the vehicle 10, with the received live data (at the diagnostic tool 170 or in some cases the server(s) 150) being used to derive the vehicle condition information in accordance with steps 230 and 240. In this way, the user need only handle a single combined tool 170 rather than a separate diagnostic tool 110 and simulator 130.

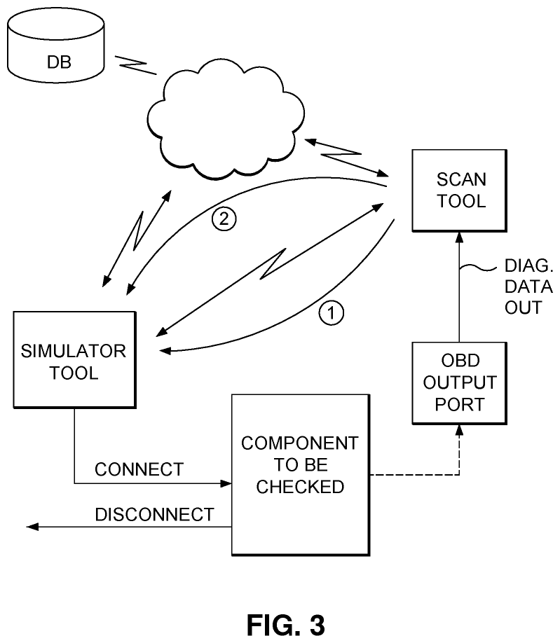

FIG. 3 shows a schematic view illustrating cyclical aspects and data paths of the disclosed system 100 and diagnostic methods. The potentially faulty operation of a component to be checked (e.g., component 12 of FIG. 1) results in diagnostic data (e.g., DTC, live data, etc.) output from an OBD output port (e.g., of vehicle 10) that is indicative of a defect. A scan tool (e.g., diagnostic tool 110 or enhanced diagnostic tool 170) may initially function to derive defect info and configure a simulator tool (e.g., separate simulator 130 or the same enhanced diagnostic tool 170) to produce proper output signals for the particular component in the particular vehicle 10 (e.g., YMME). The scan tool may configure the simulator tool according to parameters retrieved from one or more databases residing on the scan tool and/or in a cloud network. The simulator tool may be configured by the scan tool directly over a Bluetooth or other short-range wireless connection (data path 1 in FIG. 3) or may be configured via the cloud (data path 2 in FIG. 3). The simulator tool may be connected in place of the component, which may be disconnected. With the simulator tool in place, the scan tool may then determine if the component works based on whether the defect persists during simulation of the component by checking live data, freeze frame data, DTC (if reset), etc. Based on the data, updates to the simulation parameters may be made as needed, for example, to test a series of different simulator outputs, with the process repeating accordingly.

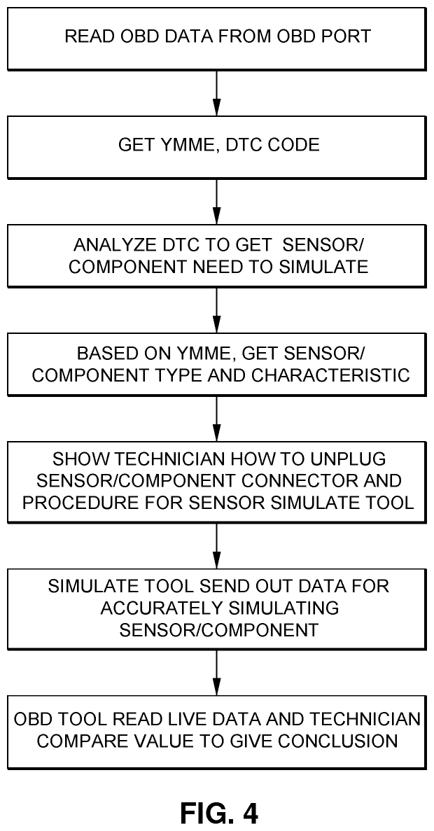

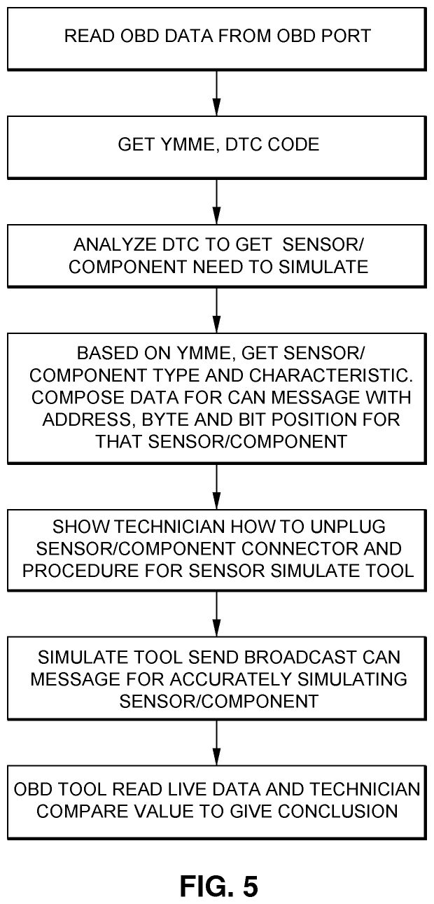

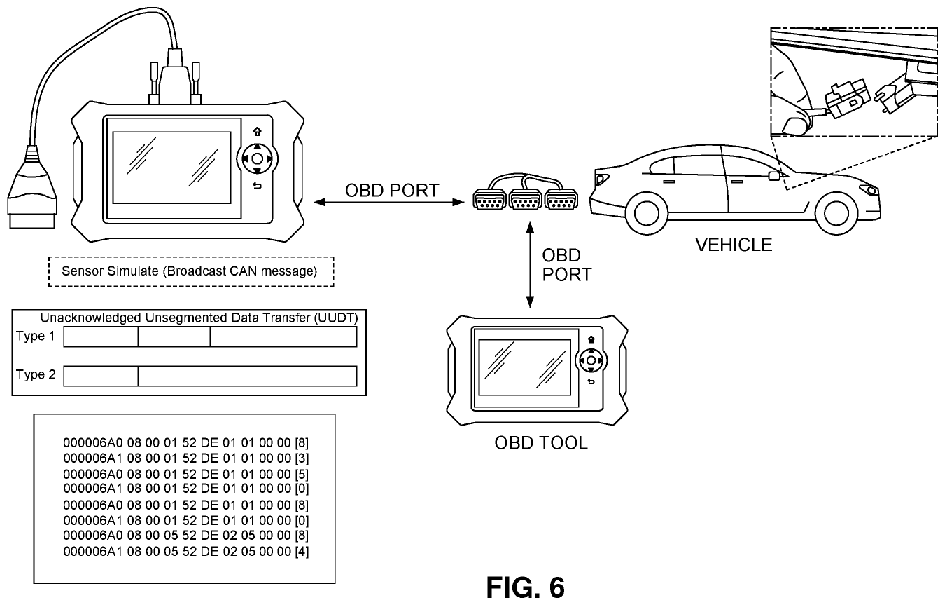

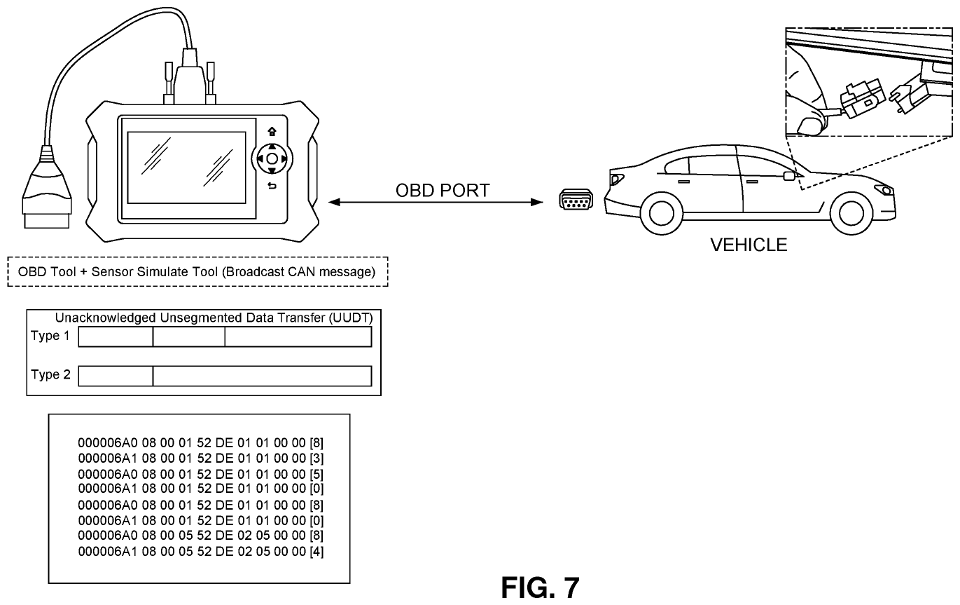

FIG. 4 shows an operational flow summarizing aspects of the disclosed subject matter discussed above in relation to FIGS. 1-3. FIG. 5 shows a related operational flow summarizing aspects of the disclosed subject matter discussed above in relation to FIGS. 1-3 in the context of a simulator 130 that is configured to broadcast messages on a CAN bus. FIGS. 6 and 7 are schematic diagrams illustrating additional aspects of the system 100 shown in FIG. 1 in the context of the simulator 130 being configured to broadcast messages on a CAN bus. FIG. 6 shows example implementations of diagnostic tools 110 (with and without cable 112) for use with a separate simulator 130 as described in relation to FIG. 1. FIG. 7 shows an implementation of a combined tool 170 as described in relation to FIG. 1.

The functionality described above in relation to the diagnostic tool 110, 170, simulator 130, mobile device 140, and server(s) 150 shown in FIG. 1 and the operational flow described in relation to FIG. 2 and FIG. 3 and throughout the disclosure (including FIGS. 4-7) may be wholly or partly embodied in one or more computers including a processor (e.g. a CPU), a system memory (e.g. RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as between the diagnostic tool 110, 170 or mobile device 140 and the server(s) 150 or between the diagnostic tool 110 or mobile device 140 and the simulator 130. To the extent that functionality may be performed by the server(s) 150, the server(s) 150 may comprise multiple physical servers and other computers that communicate with each other to perform the described functionality.

The above computer programs may comprise program instructions which, when executed by the processor, cause the processor to perform operations in accordance with the various embodiments of the present disclosure. The computer programs may be provided to the secondary storage by or otherwise reside on an external computer-readable medium such as a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of providing vehicle diagnostics, the method comprising:
receiving diagnostic data collected from an on-board diagnostics (OBD) port of a vehicle, the diagnostic data including identification information of the vehicle and at least one fault indication associated with a component of the vehicle;
deriving, from the at least one fault indication and the identification information, one or more simulated output parameters for simulating an output of the component;
receiving live data collected from the OBD port of the vehicle based on a simulated output of the component generated according to the one or more simulated output parameters; and
deriving vehicle condition information from the at least one fault indication and the live data.

2. The method of claim 1, wherein the at least one fault indication comprises at least one diagnostic trouble code (DTC).

3. The method of claim 1, wherein the one or more simulated output parameters includes at least one parameter for generating a simulated output selected from the group consisting of a simulated resistance, a simulated voltage, a simulated sine wave, a simulated square wave, a simulated temperature coefficient sensor output, a simulated throttle and pedal sensor output, a simulated oxygen sensor output, a simulated exhaust gas pressure sensor output, a simulated camshaft position (CMP) sensor output, a simulated crankshaft position (CKP) sensor output, a simulated common rail pressure sensor output, a simulated knock sensor output, a simulated manifold absolute pressure (MAP) sensor output, a simulated anti-lock braking system (ABS) sensor output, a simulated mass airflow (MAF) sensor output, a simulated heating, ventilation, and air conditioning (HVAC) pressure sensor output, a simulated signal for controlling an injector pulse of the vehicle, a simulated signal for controlling an ignitor pulse of the vehicle, and a simulated signal for controlling a solenoid pulse of the vehicle.

4. The method of claim 1, wherein the one or more simulated output parameters includes user instructions for connecting a simulator to the vehicle, the simulator being operable to generate the simulated output of the component.

5. A computer program product comprising one or more non-transitory program storage media on which are stored instructions executable by one or more processors or programmable circuits to perform operations for providing vehicle diagnostics, the operations comprising:
receiving diagnostic data collected from an on-board diagnostics (OBD) port of a vehicle, the diagnostic data including identification information of the vehicle and at least one fault indication associated with a component of the vehicle;
deriving, from the at least one fault indication and the identification information, one or more simulated output parameters for simulating an output of the component;
receiving live data collected from the OBD port of the vehicle based on a simulated output of the component generated according to the one or more simulated output parameters; and
deriving vehicle condition information from the at least one fault indication and the live data.

6. The computer program product of claim 5, wherein the at least one fault indication comprises at least one diagnostic trouble code (DTC).

7. The computer program product of claim 5, wherein the one or more simulated output parameters includes at least one parameter for generating a simulated output selected from the group consisting of a simulated resistance, a simulated voltage, a simulated sine wave, a simulated square wave, a simulated temperature coefficient sensor output, a simulated throttle and pedal sensor output, a simulated oxygen sensor output, a simulated exhaust gas pressure sensor output, a simulated camshaft position (CMP) sensor output, a simulated crankshaft position (CKP) sensor output, a simulated common rail pressure sensor output, a simulated knock sensor output, a simulated manifold absolute pressure (MAP) sensor output, a simulated anti-lock braking system (ABS) sensor output, a simulated mass airflow (MAF) sensor output, a simulated heating, ventilation, and air conditioning (HVAC) pressure sensor output, a simulated signal for controlling an injector pulse of the vehicle, a simulated signal for controlling an ignitor pulse of the vehicle, and a simulated signal for controlling a solenoid pulse of the vehicle.

8. The computer program product of claim 5, wherein the one or more simulated output parameters includes user instructions for connecting a simulator to the vehicle, the simulator being operable to generate the simulated output of the component.

9. A system for providing vehicle diagnostics, the system comprising:
a diagnostic tool operable to receive diagnostic data collected from an on-board diagnostics (OBD) port of a vehicle, the diagnostic data including identification information of the vehicle and at least one fault indication associated with a component of the vehicle, the diagnostic tool being further operable to derive, from the at least one fault indication and the identification information, one or more simulated output parameters for simulating an output of the component; and
a simulator operable to generate a simulated output of the component according to the one or more simulated output parameters.

10. The system of claim 9, wherein the at least one fault indication comprises at least one diagnostic trouble code (DTC).

11. The system of claim 10, wherein the diagnostic tool is further operable to receive live data collected from the OBD port of the vehicle based on the simulated output and derive vehicle condition information from the at least one DTC and the live data.

12. The system of claim 11, wherein the deriving of the vehicle condition information by the diagnostic tool includes uploading the at least one DTC and the live data to one or more servers and receiving the vehicle condition information from the one or more servers.

13. The system of claim 10, wherein the deriving of the one or more simulated output parameters includes uploading the at least one DTC and the identification information to one or more servers and receiving the one or more simulated output parameters from the one or more servers.

14. The system of claim 9, wherein the diagnostic tool is further operable to receive live data collected from the OBD port of the vehicle based on the simulated output and derive vehicle condition information from the at least one fault indication and the live data.

15. The system of claim 14, wherein the deriving of the vehicle condition information by the diagnostic tool includes uploading the at least one fault indication and the live data to one or more servers and receiving the vehicle condition information from the one or more servers.

16. The system of claim 9, wherein the deriving of the one or more simulated output parameters includes uploading the at least one fault indication and the identification information to one or more servers and receiving the one or more simulated output parameters from the one or more servers.

17. A system for providing vehicle diagnostics, the system comprising:
one or more servers operable to receive diagnostic data collected from an on-board diagnostics (OBD) port of a vehicle, the diagnostic data including identification information of the vehicle and at least one fault indication associated with a component of the vehicle, the one or more servers being further operable to derive, from the at least one fault indication and the identification information, one or more simulated output parameters for simulating an output of the component; and
a simulator operable to generate a simulated output of the component according to the one or more simulated output parameters.

18. The system of claim 17, wherein the at least one fault indication comprises at least one diagnostic trouble code (DTC).

19. The system of claim 18, wherein the one or more servers is further operable to receive live data collected from the OBD port of the vehicle based on the simulated output and derive vehicle condition information from the at least one DTC and the live data.

20. The system of claim 17, wherein the one or more servers is further operable to receive live data collected from the OBD port of the vehicle based on the simulated output and derive vehicle condition information from the at least one fault indication and the live data.

21. A system for providing vehicle diagnostics, the system comprising:
a data acquisition and transfer device configured to be plugged into an on-board diagnostics (OBD) port of a vehicle; and
a diagnostic tool operable to receive diagnostic data collected from the vehicle via the data acquisition and transfer device, the diagnostic data including identification information of the vehicle and at least one fault indication associated with a component of the vehicle, the diagnostic tool being further operable to derive, from the at least one fault indication and the identification information, one or more simulated output parameters for simulating an output of the component and generate a simulated output of the component according to the one or more simulated output parameters, wherein the diagnostic tool is further operable to receive live data collected from the vehicle via the data acquisition and transfer device, the live data being based on the simulated output.

22. The system of claim 21, wherein the at least one fault indication comprises at least one diagnostic trouble code (DTC).

23. The system of claim 22, wherein the diagnostic tool is further operable to derive vehicle condition information from the at least one DTC and the live data.

24. The system of claim 23, wherein the deriving of the vehicle condition information by the diagnostic tool includes uploading the at least one DTC and the live data to one or more servers and receiving the vehicle condition information from the one or more servers.

25. The system of claim 22, wherein the deriving of the one or more simulated output parameters includes uploading the at least one DTC and the identification information to one or more servers and receiving the one or more simulated output parameters from the one or more servers.

26. The system of claim 21, wherein the diagnostic tool is further operable to derive vehicle condition information from the at least one fault indication and the live data.

27. The system of claim 26, wherein the deriving of the vehicle condition information by the diagnostic tool includes uploading the at least one fault indication and the live data to one or more servers and receiving the vehicle condition information from the one or more servers.

28. The system of claim 21, wherein the deriving of the one or more simulated output parameters includes uploading the at least one fault indication and the identification information to one or more servers and receiving the one or more simulated output parameters from the one or more servers.
